(19) United States
(12) Patent Application Publication
(10) Pub. No.: US 2026/0270128 A1
(43) Pub. Date: Sep. 10, 2026

(54) APPARATUS, METHOD AND READABLE STORAGE MEDIUM FOR COMMUNICATION

(71) Applicant: Huawei Technologies Co., Ltd., Shenzhen (CN)

(72) Inventors: Liqing Zhang, Ottawa (CA); Hao Tang, Ottawa (CA); Jianglei Ma, Ottawa (CA); Xiaoyan Bi, Shanghai (CN)

(21) Appl. No.: 19/664,301

(22) Filed: Apr. 30, 2026

Related U.S. Application Data
(63) Continuation of application No. PCT/CN2024/089157, filed on Apr. 22, 2024.
(60) Provisional application No. 63/595,421, filed on Nov. 2, 2023.

(51) Int. Cl. H04L 27/26

(52) U.S. Cl. CPC H04L 27/26025; H04L 27/2607

(57) ABSTRACT

The present application relates to wireless communication field and discloses an apparatus, method and readable storage medium for communication. An example method includes receiving, from a base station, a signaling configuring a numerology in a time duration. The configuring a numerology in a time duration includes configuring a subcarrier spacing (SCS) for one or more symbols in the time duration. Each symbol of the one or more symbols includes a cyclic prefix (CP) part and a useful orthogonal frequency division multiplexing (OFDM) signal part. A time length of the useful OFDM signal part is an inverse of the SCS. A number of sampling samples of the useful OFDM signal part is an integer multiple of at least one of prime numbers 3 or 5. A time length of the CP part is in units of k sampling samples. The method further includes communicating with the base station using the numerology.

### CROSS-REFERENCE TO RELATED APPLICATIONS

The present application is a continuation of International Application No. PCT/CN2024/089157, filed on Apr. 22, 2024, which claims priority to and the benefit of U.S. Provisional Patent Application Ser. No. 63/595,421, entitled “Method and Scheme on Adaptive Numerology Application and Operations,” filed on Nov. 2, 2023. The entire contents of each of the aforementioned applications are incorporated herein by reference.

### TECHNICAL FIELD

The present application relates to wireless communication field, and in particular to an apparatus, method, and readable storage medium for communication.

### BACKGROUND

In 5G networks, the transmission of signals between devices or apparatus can be accomplished via subcarriers as frequency domain resource over a period of time as time domain resource, where subcarriers are individual frequency components in a component carrier (CC) with a carrier bandwidth (e.g., 20 MHz). Subcarriers are organized into groups called resource blocks (RBs) and each RB consists of a fixed number of subcarriers (usually 12) and spans a certain frequency range. Subcarrier spacing refers to the frequency separation between adjacent subcarriers in an Orthogonal Frequency Division Multiplexing (OFDM) system and different subcarrier spacings in 5G networks are supported, such as 15 kHz, 30 kHz, 60 kHz, 120 kHz, and 240 kHz, which are scalable over 15 kHz. A single family of numerology, i.e., scalable 15 kHz subcarrier spacing (SCS) with normal cyclic prefix (NCP) including long CP and short CP or/and extended CP (ECP), is used, as shown in FIG. 1. In FIG. 1, the family includes multiple SCS on the basis of 15 kHz SCS, as well as the corresponding short CP for each SCS. The long CP of NCP and ECP are not shown in FIG. 1.

However, the scalable characteristic of the numerology may lead to reduced CP length proportionally with the increasing of subcarrier spacing. For example, the CP length in 30 kHz SCS symbols may have (approximately) one half of CP length in 15 kHz SCS symbols, or as SCS in OFDM symbols increases, CP length in the OFDM symbols may reduce proportionally. The length of the CP determines its ability to resolve Doppler impact and/or mitigate inter-symbol interference. For example, with the increase of SCS, the length of CP decreases proportionally, and the ability of CP to deal with Doppler impact and/or mitigate inter-symbol interference becomes weaker.

Thus, the single family of numerology may not be able to handle diverse applications and use cases in future wireless network such as 6G network. For example, the current single family of numerology may not meet the needs of situations that require both large SCS and large CP to resolve relatively high Doppler impact and/or mitigate inter-symbol interference.

### SUMMARY

The following examples pertain to embodiments described throughout this application.

In a first aspect, there is provided an apparatus, comprising a memory for storing instructions and one or more processors for executing the instructions to cause the apparatus to receive, from a base station, a signaling on configuring a numerology in a time duration, wherein the configuring a numerology in a time duration comprises configuring a subcarrier spacing (SCS) for one or more symbols in the time duration, each symbol comprising a cyclic prefix (CP) part and a useful orthogonal frequency division multiplexing (OFDM) signal part. A time length of the useful OFDM signal part is an inverse of the SCS, and the number of sampling samples of the useful OFDM signal part is integer multiple of at least one of prime numbers of 3 or 5. A time length of the CP part is in units of k sampling samples, wherein, k is a non-negative integer. The apparatus is further configured to communicate with the base station using the numerology.

The numerology disclosed in this application is different from the 15 kHz numerology. For example, the number of sampling samples of the useful OFDM signal part is 2048 in 5G 15 kHz SCS, which is the integer multiple of 2. While for numerology disclosed here, the number of sampling samples of the useful OFDM signal part is integer multiple of at least one of prime numbers of 3 or 5, which is applicable for a digital signaling processing such as Discrete Fourier Transform (DFT).

In one or more possible implementations of the first aspect, the time duration is a subframe of 1 ms, a half subframe of 0.5 ms, or any other reference time period.

In one or more possible implementations of the first aspect (proposed here), the SCS is a family of scalable SCSs of 16×2ⁿ kHz, or the SCS is a family of scalable SCSs of 12×2ⁿ kHz, wherein n is an integer.

Compared with the 15 kHz numerology family, disclosed are two kinds of numerology families, which are 16 kHz family and 12 kHz family. For example, the 16 kHz family may have scalable SCSs with 16 kHz, 32 kHz, 64 kHz, 128 kHz, etc. The 12 kHz family may have scalable SCSs with 12 kHz, 24 kHz, 48 kHz, 96 kHz, etc.

In one or more possible implementations of the first aspect, the time length of the CP part comprises two types of lengths for a short CP part and a long CP part, respectively, which are referred to as normal CPs; and, a first symbol comprising the long CP part and the useful OFDM signal part is referred to as a long symbol, and a second symbol comprising the short CP part and the useful OFDM signal part is referred to as a short symbol.

In one or more possible implementations of the first aspect, a time length difference between the long symbol and the short symbol has a fixed time length in M number of sampling samples, and M is an integer multiple of 16.

In one or more possible implementations of the first aspect, when the SCS is the family of scalable SCSs of 16×2ⁿ kHz, for a 16 kHz symbol, the number of sampling samples of the useful OFDM signal part or Discrete Fourier Transform (DFT) size is 1920; and, the number of sampling samples of the short CP part is 272; the number of sampling samples of the long CP part is 288.

The number of sampling samples of the short CP part of 16 kHz symbol is 272, which is larger than that of 15 kHz symbol which is 144, and 16 kHz is greater than 15 kHz in subcarrier spacing. This means that ability of 16 kHz symbol for dealing with Doppler impact and inter-symbol interference caused by scenarios such as using high frequency bands, with abound of multi-paths, large cell or/and fast mobility situations is better than that of 15 kHz symbol at a cost of a bit larger overhead of the CP.

In one or more possible implementations of the first aspect, when the SCS is the family of scalable SCSs of 12×2ⁿ kHz, for a 48 kHz symbol, the number of sampling samples of the useful OFDM signal part or DFT size is 640; and, the number of sampling samples of the short CP part is 90; the number of sampling samples of the long CP part is 106.

The short CP overhead of the 48 kHz numerology family is about 12.57%, which is higher than that of 15 kHz numerology family. However, the 48 kHz numerology family has a stronger capacity in dealing with Doppler impact and ISI than 15 kHz numerology family. For example, the short CP length of 60 kHz short symbol (in the 15 kHz numerology family) is 1.17 us, while the short CP length of 96 kHz short symbol is 1.50 us. It means that short CP of 96 kHz symbol has a stronger capacity in dealing with Doppler impact (due to larger SCS) and ISI (due to larger CP) than the SCS of 60 kHz in the 15 kHz numerology family. So the 48 kHz numerology family is applicable to situations that require both large SCS and large CP.

In one or more possible implementations of the first aspect, the time length of the CP part comprises single time length for each symbol, which is referred to as extended CP (ECP) part, wherein each symbol has same time duration.

In one or more possible implementations of the first aspect, when the SCS is the family of scalable SCSs of 12×2ⁿ kHz, for a 48 kHz symbol, the number of sampling samples of the ECP part is 128.

The ECP overhead of 48 kHz SCS is about 128/(128+640), or 16.7%, which is smaller than that of 60 kHz SCS in the 15 kHz numerology family with 20%. It means that the ECP overhead of each SCS in the 12 kHz numerology family is smaller than that in the 15 kHz numerology family, making the transmission spectrum efficiency improved.

In one or more possible implementations of the first aspect, the time length of the ECP part is zero, and an integer number of the symbols in the family of scalable SCSs of 12×2ⁿ kHz fits exactly into the time duration.

The transmission spectrum efficiency will be improved further when the length of ECP part can be set to zero. In this condition, 6 number of 12 kHz symbol without CP can fit into a half subframe, and 12 number of 24 kHz symbols without CP can fit into a half subframe, etc.

In one or more possible implementations of the first aspect, 24 number of 48 kHz symbols without any CP part fit exactly into the half subframe.

In one or more possible implementations of the first aspect, one or more symbols from the family of scalable SCSs of 16×2ⁿ kHz, or the family of scalable SCSs of 12×2ⁿ kHz are used to replace one or more symbols from a family of scalable SCSs of 15×2ⁿ kHz, wherein n is an integer.

Since the 16 kHz symbols and 12 kHz symbols can fit into half subframe or a subframe, one or more 16 kHz symbols and 12 kHz symbols can replace symbols of 15 kHz numerology family, in order to achieve related signal transmission performance, such as channel estimation, data throughput and feedback speed.

In a second aspect, there is provided a method, comprising: receiving, by an apparatus from a base station, a signaling on configuring a numerology in a time duration, wherein the configuring a numerology in a time duration comprises configuring a subcarrier spacing (SCS) for one or more symbols in the time duration, each symbol comprising a cyclic prefix (CP) part and a useful orthogonal frequency division multiplexing (OFDM) signal part, wherein a time length of the useful OFDM signal part is an inverse of the SCS, and the number of sampling samples of the useful OFDM signal part is integer multiple of at least one of prime numbers of 3 or 5, and a time length of the CP part is in units of k sampling samples, wherein, k is a non-negative integer; communicating, by the apparatus, with the base station using the numerology.

In one or more possible implementations of the second aspect, the time duration is a subframe of 1 ms, a half subframe of 0.5 ms, or any other reference time period.

In one or more possible implementations of the second aspect (proposed here), the SCS is a family of scalable SCSs of 16×2ⁿ kHz, or the SCS is a family of scalable SCSs of 12×2ⁿ kHz, wherein n is an integer.

In one or more possible implementations of the second aspect, the time length of the CP part comprises two types of lengths for a short CP part and a long CP part, respectively, which are referred to as normal CPs; and, a first symbol comprising the long CP part and the useful OFDM signal part is referred to as a long symbol, and a second symbol comprising the short CP part and the useful OFDM signal part is referred to as a short symbol.

In one or more possible implementations of the second aspect, a time length difference between the long symbol and the short symbol has a fixed time length in M number of sampling samples, and M is an integer multiple of 16.

In one or more possible implementations of the second aspect, when the SCS is the family of scalable SCSs of 16×2n kHz, for a 16 kHz symbol, the number of sampling samples of the useful OFDM signal part or Discrete Fourier Transform (DFT) size is 1920; and, the number of sampling samples of the short CP part is 272; the number of sampling samples of the long CP part is 288.

In one or more possible implementations of the second aspect, when the SCS is the family of scalable SCSs of 12×2ⁿ kHz, for a 48 kHz symbol, the number of sampling samples of the useful OFDM signal part or DFT size is 640; and, the number of sampling samples of the short CP part is 90; the number of sampling samples of the long CP part is 106.

In one or more possible implementations of the second aspect, the time length of the CP part comprises single time length for each symbol, which is referred to as extended CP (ECP) part, wherein each symbol has same time duration.

In one or more possible implementations of the second aspect, when the SCS is the family of scalable SCSs of 12×2ⁿ kHz, for a 48 kHz symbol, the number of sampling samples of the ECP part is 128.

In one or more possible implementations of the second aspect, the time length of the ECP part is zero, and an integer number of the symbols in the family of scalable SCSs of 12×2ⁿ kHz fits exactly into the time duration.

In one or more possible implementations of the second aspect, 24 number of 48 kHz symbols without any CP part fit exactly into the half subframe.

In one or more possible implementations of the second aspect, one or more symbols from the family of scalable SCSs of 16×2ⁿ kHz, or the family of scalable SCSs of 12×2ⁿ kHz are used to replace one or more symbols from a family of scalable SCSs of 15×2ⁿ kHz, wherein n is an integer.

In a third aspect, there is provided a machine-readable storage medium storing instructions, wherein when the instructions are executed by one or more processors of a machine, the instructions cause the machine to execute any of the methods described herein.

In a fourth aspect, there is provided an apparatus, wherein the apparatus comprises a function or a unit to perform any of the methods described herein.

In a fifth aspect, there is provided a non-transitory computer-readable medium storing instructions, the instructions causing a processor in a device to implement any of the methods described herein.

In a sixth aspect, there is provided a device configured to perform any of the methods described herein.

In a seventh aspect, there is provided a processor, configured to execute instructions to cause a device to perform any of the methods described herein.

In an eighth aspect, there is provided an integrated circuit configured to perform any of the methods described herein.

The beneficial effects of the second aspect to the eighth aspect can be referred to that of the first aspect, which will not be described in detail herein again.

### BRIEF DESCRIPTION OF THE DRAWINGS

FIG. 1 shows information of CP of 15 kHz SCS numerology family according to some examples of the present application.

FIG. 2 shows a schematic diagram of the relationship between the length of the 15 kHz symbols with a subframe according to some examples of the present application.

FIG. 3A shows a schematic flow diagram of a communication method according to some examples of the present application.

FIG. 3B shows a schematic diagram of the length relationship between a 15 kHz short symbol and a 16 kHz short symbol according to some examples of the present application.

FIG. 4 shows a schematic diagram of an alignment within 0.5 ms for 15 kHz and 16 kHz numerology symbols according to some examples of the present application.

FIG. 5 shows information of 16 kHz numerology family with normal CP according to some examples of the present application.

FIG. 6 shows a schematic diagram of the length relationship between a 15 kHz short symbol and a 48 kHz short symbol according to some examples of the present application.

FIG. 7 shows a schematic diagram of an alignment within 0.5 ms for 15 kHz and 48 kHz numerology symbols according to some examples of the present application.

FIG. 8 shows information of 48 kHz numerology family with normal CP according to some examples of the present application.

FIG. 9 shows information of 12 kHz numerology family with ECP according to some examples of the present application.

FIG. 10 shows information of 12 kHz numerology family, including scenarios with zero CP according to some examples of the present application.

FIG. 11 shows a first schematic diagram of symbol configuration in DL and UL transmission according to some examples of the present application.

FIG. 12 shows a second schematic diagram of symbol configuration in DL and UL transmission according to some examples of the present application.

FIG. 13 shows a schematic diagram of symbol configuration within a subframe according to some examples of the present application.

FIG. 14 shows a first schematic structural diagram of a communication system 100 according to some examples of the present application.

FIG. 15 shows a second schematic structural diagram of a communication system 100 according to some examples of the present application.

FIG. 16 shows a schematic diagram of communication between ED 110 and base station according to some examples of the present application.

FIG. 17 shows a schematic diagram of modules in each apparatus of a communication system 100 according to some examples of the present application.

FIG. 18 shows a third schematic structural diagram of a communication system 100 including a sensing agent according to some examples of the present application.

FIG. 19 shows a schematic structural diagram of a sensing management function according to some examples of the present application.

### DETAILED DESCRIPTION OF ILLUSTRATIVE EMBODIMENTS

Illustrative embodiments of the present application include, but are not limited to, an apparatus, method, and readable storage medium for communication.

The OFDM symbols of the 15 KHz SCS (15 kHz symbols for short in the following) in the 15 KHz SCS numerology family are described first in the following content.

FIG. 2 shows a schematic diagram of the relationship between the length of the 15 kHz symbols with a subframe. As shown in FIG. 2, a subframe represents 1 ms, and a subframe of 1 ms can be divided into two half subframes, with each half subframe being 0.5 ms in length. The length of 0.5 ms can include seven 15 kHz symbols in time domain. In addition, the seven 15 kHz symbols can be further divided into one long (OFDM) symbol and six (OFDM) short symbols, where the long symbol and each short symbol differ in length.

The long symbol includes long CP and useful symbol part, and each short symbol includes short CP and useful symbol part. The long symbol and the short symbol have the same length of the useful symbol part, and the length of the useful symbol part is the inverse of the corresponding SCS. That is to say, the length of useful symbol part of a 15 kHz symbol is 1/15000 in seconds.

The length in this application represents the time duration.

Illustratively, 15 kHz SCS is a concept in frequency domain. In the process of signal transmission, the signal may be converted from the frequency domain into time domain. At this point, Fast Fourier Transform (FFT) or Digital Fourier Transform (DFT) can be conducted to obtain time domain signal through sampling the signal in frequency domain. A FFT size or DFT size, N, and subcarriers with SCS may lead to a sampling rate of N*SCS Hz for the time domain signal processing. As an example, the FFT size of 2048 and 15 kHz SCS may have a sampling rate of 15000*2048 Hz=30.72 MHz, and thus the sampling period is 1/(15000*2048) seconds. A sampling rate may be associated with a (maximum) channel bandwidth of a carrier component (or a carrier bandwidth). For OFDM signal using transceiver with I and Q paths based on a quadrature processing system, a sampling rate is able to reliably process the OFDM signal in a carrier component with a channel bandwidth, wherein the sampling rate may not necessarily be more than two times of the channel bandwidth of the carrier component. For example, the FFT size of 2048 and 15 kHz SCS with a sampling rate of 30.72 MHz may be able to support the maximum channel bandwidth of 20 MHz for an OFDM signal. Note that in the application, FFT size of 2048 and 15 kHz SCS in applicable to 20 MHz bandwidth as a reference to address other numerology designs (In general, a higher FFT size, such as 4096 in New Radio (NR), can also be used to define a sampling rate/period and address new numerology designs, but may lead to the same solutions to the proposed families of scalable numerology options).

In addition, the number of samples corresponding to short CP in short symbols of 15 kHz SCS is 144. The length of the short CP can be obtained from the number of samples of short CP, the number of samples of useful symbol part, and the sampling period, which is 4.69 μs as shown in FIG. 1. The number of samples corresponding to long CP in the long symbol of 15 kHz SCS is (144+16), which is 160. Thus, the total length of one long symbol and six short symbols corresponding to 15 kHz SCS is 0.5 ms. That is to say, one long symbol and six short symbols can fit into 0.5 ms.

In this case, the overhead of short CP is 144/(144+2048)=6.6%, and that of long CP is 160/(160+2048)=7.25%.

In addition, for 30 kHz SCS, the length of the useful symbol part is about half of that of 15 kHz SCS, so does the length of short CP, but the overhead of short CP and long CP is the same with that of 15 kHz SCS respectively.

Therefore, as shown in FIG. 1, the short CP overhead is relatively small, which means that the ability of CP to deal with Doppler impact or mitigate inter-symbol interference is weak. Thus, the current single 15 kHz numerology may not meet the needs of situations that require both large SCS and large CP to resolve relatively high Doppler impact or mitigate inter-symbol interference. These situations are described in detail below.

For example, in scenarios or applications of high frequency bands such as mm Wave bands, higher signal bandwidth (e.g., >20 MHz) signal processing or/and with fast mobility (e.g., >200 km/h) situations, a high SCS (e.g., 120 kHz) may be required. Due to the reduction of CP length, the high SCS signal may not be applicable to occasions such as wireless channels with abound of multi-paths, relatively large cell size or/and fast mobility traffic situations, as these occasions may need high SCS to resolve high Doppler impact or mitigate inter-symbol interference.

In other words, higher SCS is usually required in high frequency band scenarios. For example, if the signal occupies a channel bandwidth of 100 MHz, then if 15 kHz SCS is used, there are about 6667 subcarriers. The number is too large to process. At this point, if 120 kHz SCS is selected, only 833 subcarriers are included in the 100 MHz bandwidth, and the number of sub-carriers is less, which is reasonable number of subcarriers for processing and can reduce the complexity of signal processing. However, based on FIG. 1, the length of short CP corresponding to the 120 kHz SCS is only 0.58625, making it difficult for the short CP to resolve Doppler impact and/or reduce inter-symbol interference (ISI).

A fast mobility situation may result in Doppler impact. For example, in a high-speed railway, there will be a more severe Doppler impact during the transmission of a signal, which may cause the distortion of the signal. In this case, a larger CP length is needed to address the Doppler impact to a greater extent.

For another example, the inter-symbol interference between signals is more serious when the signals are transmitted in an environment with abound of multi-paths. For another example, when the cell size is relatively large, the distortion of the signals transmitted in the cell will be more serious, so a larger CP length is also needed to mitigate the inter-symbol interference or the distortion.

Therefore, SCS and CP length of the 15 kHz numerology family cannot meet requirements of scenarios or applications in high frequency bands with abound of multi-paths, relatively large cell size or/and fast mobility traffic situations.

On the other hand, for a larger SCS (larger than 15 kHz) in the 15 kHz numerology family, e.g., 60 kHz, if NCP is too small for a use scenario (e.g. scenarios described above), we may use its extended CP; however, the overhead of ECP (extended CP) in the 15 kHz numerology family is quite high, i.e., the ECP may take 20% of the OFDM symbol duration.

In the 15 kHz numerology family, only 60 kHz symbols have ECP, which is approximately 4.17 us in length, and the total length of the corresponding symbol is approximately 20.84 us. The length of ECP as a portion of the total length of the 60 kHz symbol is the overhead of ECP. So, in this case, the overhead of ECP is 20%. However, the ECP overhead is too large, which results in the low transmission spectrum efficiency.

Therefore, in above scenarios or use cases, there is a trade-off between CP length versus CP overhead to balance addressing ISI issue and resource usage efficiency. As described previously, for a larger SCS (larger than 15 kHz) in the numerology family, e.g., 120 kHz, the NCP length and CP overhead is small but the CP length is too small to be applicable to above mentioned use scenarios. Thus, its extended CP may have to be used; however, the overhead of ECP in the 15 kHz numerology family is quite high, i.e., the ECP may take 20% of the OFDM symbol duration.

In conclusion, the current network such as NR takes a single family of numerology, i.e., scalable 15 kHz SCSs with normal cyclic period (NCP) or/and extended CP, where the NCP is too small for a higher SCS option while the overhead of ECP is too large for the higher SCS option.

As a result, it is expected that it would be advantageous if a high SCS signal may support a higher SCS requirement meanwhile trying to use a CP length reasonably large enough (but not too large in order to minimize CP overhead) to support the scenarios as described above so as to address the inter-symbol interference and/or high Doppler impact. In other words, under certain use scenarios (e.g., high frequency bands, abound of paths, large cell or/and fast mobility), numerology options with reasonably large CP lengths for a large SCS may be needed to support these use scenarios or applications in a future wireless network.

In order to solve the problems mentioned above, more SCS options or more numerology families are proposed in this application to provide more SCSs and CP options to accommodate diverse application requirements in future wireless network.

New numerology schemes with benefits of high SCS with reasonably large CP length are proposed. Specifically, a numerology family of 16 kHz with NCP is proposed, with NCP overhead around 12.41%, and another numerology family of 12 kHz with NCP or ECP is proposed, with NCP overhead around 12.57% and ECP overhead around 16.67%. The two numerology families may have scalable SCSs with reasonable CP lengths that can replace options of 15 kHz family numerology to address problems in the scenarios or applications described above.

Specifically, one family (16 kHz) of numerology with CP overhead for NCP is about 12.41%, wherein the 16 kHz numerology family can provide larger SCS and larger NCP length and its capacity on dealing with Doppler impact and ISI is better than that of 15 kHz numerology family.

Another family (12 kHz) of numerology with CP overhead for NCP is about 12.57%, wherein the 12 kHz numerology family can provide larger SCS and larger NCP length and its capacity on dealing with Doppler impact and ISI is better than that of 15 kHz numerology family.

In other examples of proposed 12 kHz numerology family, ECP overhead for 12 kHz numerology family is about 16.7% (which is smaller than 20% of ECP overhead in 15 kHz), as the 12 kHz numerology family can provide smaller ECP overhead than that of 15 kHz numerology family, which can improve the transmission spectrum efficiency.

The proposed new numerologies may be complementary to the disadvantages of the current 15 kHz numerology family. The proposed numerology families satisfy the requirements of high SCS and (relatively) large CP length for certain scenarios or use cases in future wireless networks (e.g., 6G). Applicable scenarios such as using high frequency bands (e.g., 6 GHz+ frequency bands), with abound of multi-paths, large cell or/and fast mobility may use the proposed numerologies. For example: WuS (wake-up signal) from a device or base station, SR (scheduling request) or RACH (random access channel) procedure in high frequency bands (e.g., mmWAVE or higher frequency bands or/and with fast moving conditions); fast UL feedback/HARQ in above scenarios.

Specifically, new numerologies proposed above are able to resolve the following scenarios or use cases which may require reasonably large CP length to resolve Doppler impact or/and inter-symbol interference (ISI):

Situation 1: Higher frequency bands are used (that may require larger SCS) with wireless environments being full of multi-paths or/and high mobility scenarios.

A fast mobility situation may result in serious Doppler impact, and the ISI between signals is more serious when the signals are transmitted in multi-paths. A relatively large CP length is needed in these situations. Relatively large SCS is needed when the frequency bands are high. When higher frequency bands are used with wireless environments being full of multi-paths or/and high mobility scenarios, relatively large SCS and CP length are needed at the same time.

Situation 2: Application or traffic with low-latency (and high reliability) end-end requirement where a large SCS is required to reduce air-link transmission and feedback time, in wireless environments being full of multi-paths or/and high mobility scenario.

A larger CP length is required in situations of transmissions with multi-paths and in high mobility scenarios. In addition, if lower transmission delay is required during the signal transmission, larger SCS may be needed to reduce transmission time and the feedback time. The reason is that the larger the SCS is, the smaller the SCS symbol length is, so when a shorter symbol's transmission is finished, the feedback can be conducted quicker, thus reducing the feedback time.

Situation 3: Fast moving network device or/and node communicating among them in environments full of multi-paths.

In a fast moving network device, the Doppler impact is severe and the ISI between signals is more serious when the signals are transmitted in multi-paths. Thus, a relatively large CP length is needed in these situations.

Situation 4: Carrier aggregation communication with high and low frequency bands in a fast moving scenario or/and in environments full of multi-paths.

When an electronic device (e.g. user equipment) communicates with two different base stations, if one base station communicates with the device on the basis of a higher frequency band and the other base station communicates with the device on the basis of a smaller frequency band, the device may need larger SCS to meet requirement of the higher frequency band in above scenarios. In addition, in a fast moving scenario or/and in environments full of multi-paths, a large CP is usually required.

The proposed numerology families may work jointly with 15 kHz SCS family SCSs seamlessly in terms of e.g., symbol, subframe, frame alignment, sampling rate/frequency, etc. Note that a symbol in this application refers to an OFDM symbol or single-carrier Frequency Division Multiple Access (FDMA) symbol. One duration of 0.5 ms may include multiple symbols, comprising, for example, one long symbol and multiple short symbols for numerology with NCP, where a long symbol may include a long CP and useful (OFDM) symbol part, and a short symbol may include a short CP and useful (OFDM) symbol part.

To harmonize operation smoothly between the 15 kHz numerology family and newly proposed numerologies, a timing alignment within a time duration such as a half subframe (e.g., 0.5 ms), a subframe or frame is also required to accommodate the signaling processing, cross-cell interference mitigation, and/or UL synchronization at a base station. That is to say, the symbols of the newly proposed numerologies will fit into a time duration as the 15 kHz symbols do.

The 16 kHz numerology family in this application has corresponding NCP including long CP and short CP, and it doesn't have corresponding applicable ECP that is able to fit multiple OFDM symbols into a type time duration such as a subframe or 0.5 ms. While for the 12 kHz numerology family, it has corresponding NCP as well as ECP. Illustratively, the 12 kHz numerology family can also be called the 48 kHz numerology family, because 48 kHz SCS and the 12 kHz SCS belong to the same numerology family.

In methods of this application, a signaling on configuring a numerology in a time duration may be sent to an apparatus from a base station. After the apparatus receives the signaling, the apparatus can use the numerology indicated by the signaling to communicate with the base station. Specifically, the numerology indicated by the signaling may be the 12 kHz numerology or 16 kHz numerology mentioned above.

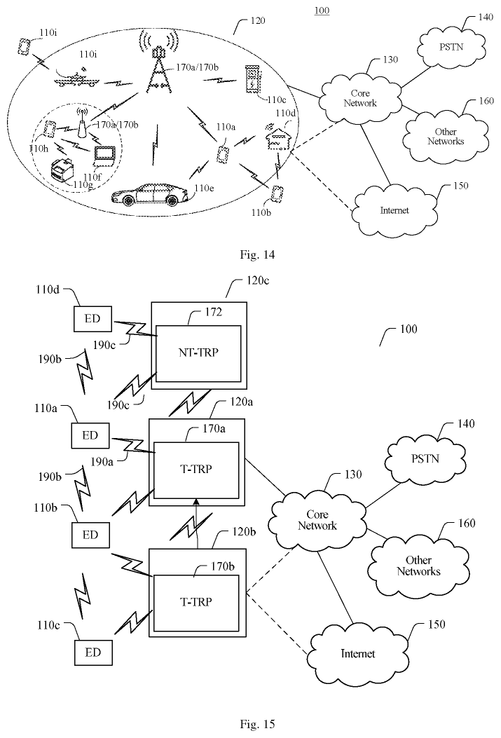

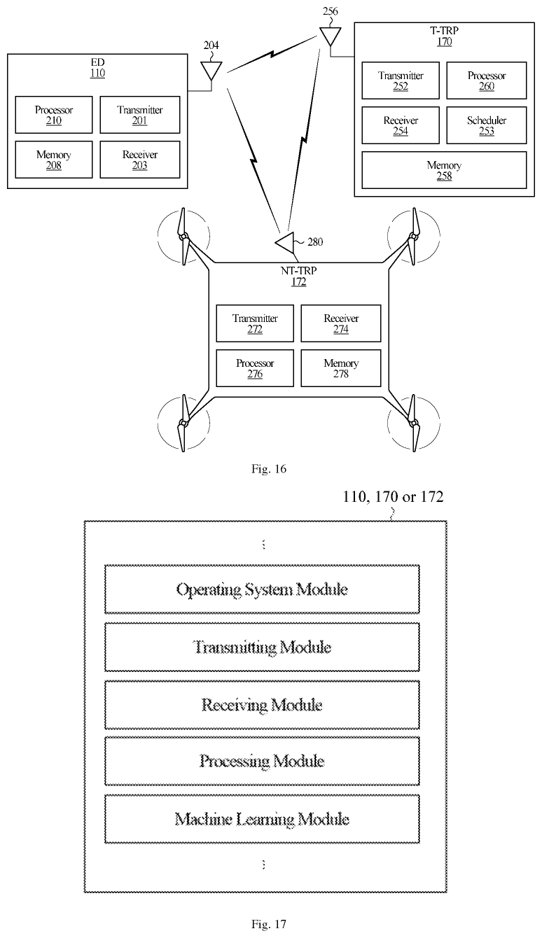

In some embodiments, the communication between the apparatus and the base station may be based on the 5G, or 6G system mentioned in the following FIG. 14, and the apparatus may be ED in FIG. 15 and FIG. 16.

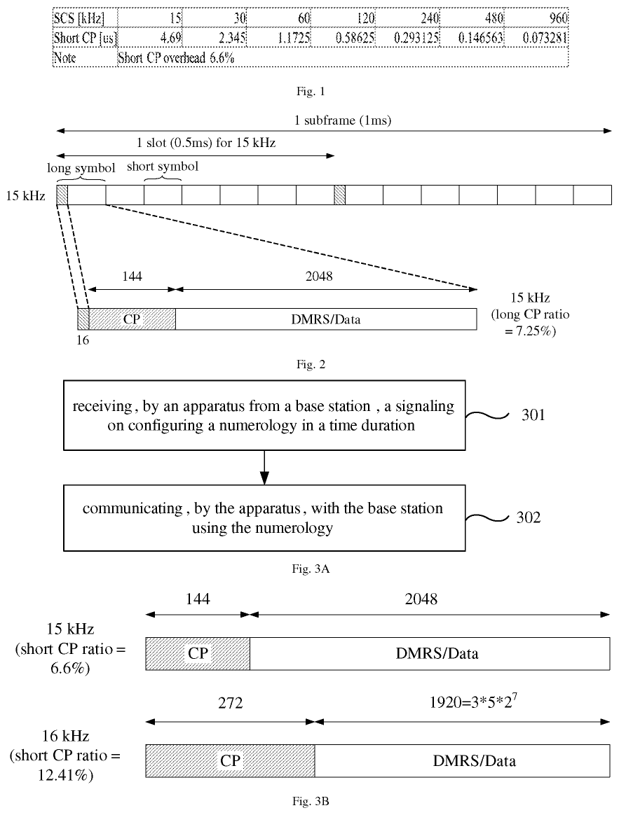

FIG. 3A shows a schematic flow diagram of a communication method according to some examples of this present application. And the communication method applied to the apparatus may include the following steps:

301: receiving, by an apparatus from a base station, a signaling on configuring a numerology in a time duration.

In some embodiments, the configuring a numerology in a time duration comprises configuring a subcarrier spacing (SCS) for one or more symbols in the time duration, each symbol comprising a cyclic prefix (CP) part and a useful orthogonal frequency division multiplexing (OFDM) signal part, wherein a time length of the useful OFDM signal part is an inverse of the SCS, and the number of sampling samples of the useful OFDM signal part is integer multiple of at least one of prime numbers of 3 or 5, and a time length of the CP part is in units of k sampling samples, wherein, k is a non-negative integer.

In some embodiments, the time duration is a subframe of 1 ms, or a half subframe of 0.5 ms. The numerology may be the 12 kHz numerology, with scalable SCSs of 12×2ⁿ kHz, or the numerology may be the 16 kHz numerology, with scalable SCSs of 16×2ⁿ kHz.

In some embodiments, the number of sampling samples of the useful OFDM signal part or the DFT size of the 12 kHz numerology and the 16 kHz numerology is integer multiple of at least one of prime numbers of 3 or 5. That is to say, the DFT size of the 12 kHz numerology and the 16 kHz numerology may be integer multiple of 3, 5, or 3*5, which is different from that of the 15 kHz numerology, because the DFT size of the 15 kHz numerology is integer multiple of 2.

The detailed description of the 12 kHz numerology and the 16 kHz numerology will be described in the following.

302: communicating, by the apparatus, with the base station using the numerology.

After the apparatus receives the signaling, the apparatus can use the signaling to communicate with the base station.

16 kHz and 48 kHz numerology families with normal CP (NCP) will be first introduced in the following content.

In this embodiment, 16 kHz and 48 kHz numerology families with normal CP are proposed with relatively larger CP lengths (or CP overheads) than that of 15 kHz numerology family.

Firstly, the 16 kHz numerology family with normal CP and symbol alignment is described in the following content.

As mentioned above, the 16 kHz symbols include the long symbol and the short symbol. The long symbol includes a long CP and useful symbol part; and the short symbol includes a short CP and useful symbol part. What's more, the long symbol length of 16 kHz is the same as that of 15 kHz, the short symbol length of 16 kHz is also the same as that of the 15 kHz.

The following describes the length of a 16 kHz short symbol in the 16 kHz numerology family proposed in this application, based on a 15 kHz short symbol. FIG. 3B shows a schematic diagram of the length relationship between a 15 kHz short symbol and a 16 kHz short symbol.

For 16 kHz numerology family with scalable SCSs: 16 kHz*2\hat{ }n, where n= . . . 2, −1, 0, 1, 2, 3, 4 . . . , the short CP overhead is about 12.41%. As shown in FIG. 3B, the duration of 16 kHz (short) symbol is equal to the one of 15 kHz short symbol, where for example, a short symbol in NCP design comprises a short CP and a useful OFDM symbol part.

Short CP length and useful OFDM symbol duration in 16 kHz short symbol are 272 Ts and 1920 Ts, respectively, Ts=1000/(15*2048)=0.032552 μs; short CP length and useful OFDM symbol duration in 15 kHz symbol are 144 Ts and 2048 Ts, respectively, which is given in FIG. 3B. It is noted that the number of samples of 1920 in 16 kHz symbol can be factored into prime numbers of 2, 3 and 5 as 1920=3*5*27, which can be applied in efficient DFT (Discrete Fourier Transformation) processing. Note also that the sampling rate or sampling period is the same for processing 16 kHz and 15 kHz OFDM signals, i.e., the sampling rate is 15000*2048=16000*1920, and the sampling period (or sampling time interval)=1/(15000*2048)=1/(16000*1920) seconds=32.552 ns (which is Ts).

The length of useful symbol part of the 16 kHz symbol is 1/16000, and because the sampling period is the same which is, 1/(15000*2048), the number of samples for the useful symbol part of the 16 kHz symbol is 1/16000÷(1/(15000*2048)), which is 1920, which is its DFT size. Since the length of the 15 kHz short symbol is kept the same as that of the 16 kHz short symbol, the number of samples for the 16 kHz short symbol can be further determined to be 272 for a short CP. Thus, the short CP overhead is 272/(272+1920)=12.41%.

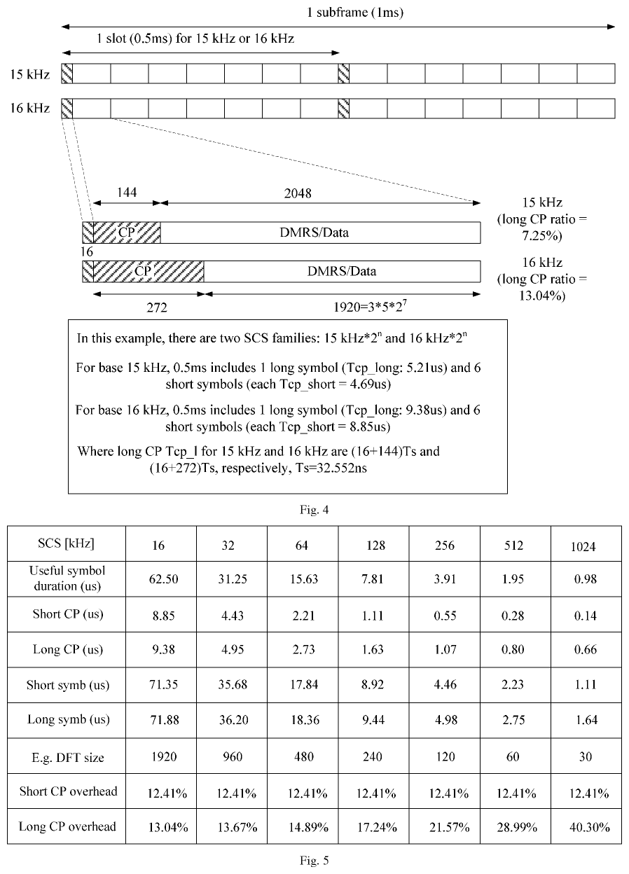

An alignment for 15 kHz, and 16 kHz numerology symbols is possible within 0.5 ms or within a half subframe. FIG. 4 shows an alignment within 0.5 ms for 15 kHz and 16 kHz numerology symbols, where for 15 kHz SCS, 0.5 ms includes 1 long symbol (T_{cp_long}: 5.21 us) and 6 short symbols (each T_{cp_short}=4.69 us); for 16 KHz SCS, 0.5 ms includes 1 long symbol (T_{cp_long}: 9.38 us) and 6 short symbols (each T_{cp_short}=8.85 us).

Specifically, as shown in FIG. 4, the number of samples of NCP in 16 kHz long symbol (or long CP) is (272+16), or 288. Because the length of the 15 kHz short symbol is the same as that of the 16 kHz short symbol, the length of the 15 kHz long symbol is also the same as that of the 16 kHz long symbol. Therefore, half subframe (0.5 ms) also includes one 16 kHz long symbol and six 16 kHz short symbols. In addition, the overhead of long CP of 16 kHz long symbol is 288/(288+1920), or 13.04%.

A 16 kHz numerology family with normal CP is shown in FIG. 5, where for example, long CPs and long symbols (each comprising a long CP and a useful OFDM symbol part) are provided, with long CP lengths and overheads estimated.

In the case of 16 kHz, the useful symbol part is 1/16000 in length, or 62.5 us. The number of samples of short CP is 272 and the sampling period is 1/(15000*2048), so the length of short CP is the product of the number of samples and the sampling period, which is 8.85 us. The number of samples of long CP is 288 and the sampling period is 1/(15000*2048), so the length of long CP is 9.38 us.

In addition, the length of the short symbol is the sum of the length of the short CP and the useful symbol part, so it is (62.50+8.85), or 71.35 us. The length of the long symbol is the sum of the length of the long CP and the useful symbol part, so it is (62.50+9.38), or 71.88 us. The overheads of a 16 kHz long CP and a 16 kHz short CP have been described previously and will not be repeated again herein.

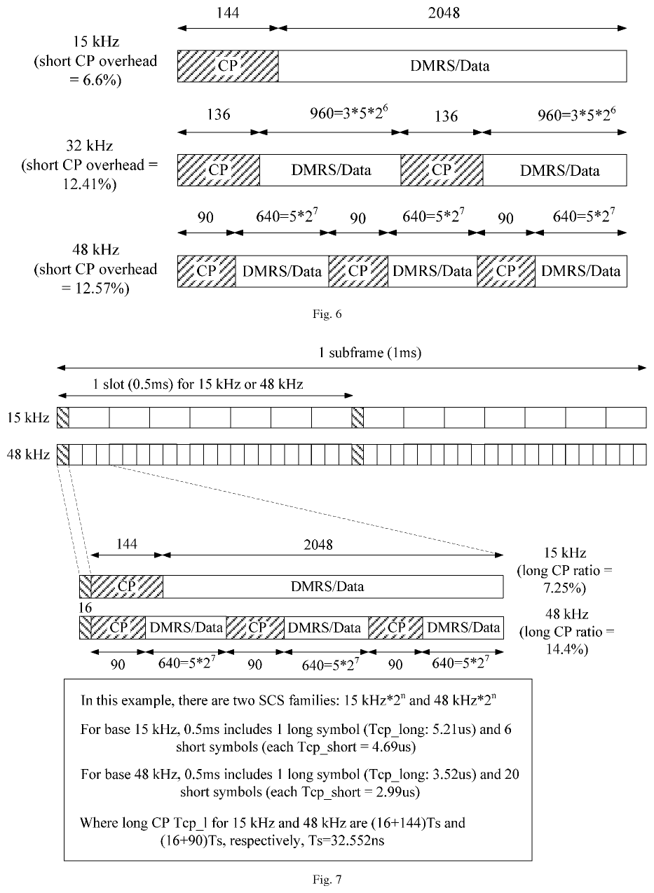

The rest of the information in FIG. 5 is calculated in the same way and will not be repeated again here (some details of 32 kHz SCS are provided in FIG. 6 also and described there).

In a word, the short CP overhead of the 16 kHz numerology family is about 12.41%, which is higher than that of 15 kHz numerology family, which provides a trade-off that the 16 kHz numerology family has a stronger capacity in dealing with Doppler impact and ISI than 15 kHz numerology family. For example, the short CP length of 60 kHz short symbol in 15 kHz numerology family is 1.17 us, while the short CP length of 64 kHz short symbol in the 16 kHz numerology family is 2.21 us. It means that short CP of 64 kHz symbol has a stronger capacity in dealing with Doppler impact and ISI with larger SCS. Thus, the 16 kHz numerology family is applicable to situations that require both large SCS and large CP.

Secondly, the 48 kHz numerology family with normal CP and symbol alignment is described in the following.

The following describes the length of a 48 kHz short symbol in the 48 kHz numerology family proposed in this application, based on a 15 kHz short symbol. FIG. 6 shows a schematic diagram of the length relationship between a 15 kHz short symbol and a 48 kHz short symbol.

The 48 kHz numerology family with scalable SCSs is described by: 48 kHz*2\hat{ }n, where n= . . . 2, −1, 0, 1, 2, 3, 4 . . . , the short CP overhead is about 12.57%. The duration of 48 kHz (short) symbol is equal to one third of 15 kHz short symbol (i.e., a symbol alignment). Short CP length and useful OFDM symbol duration in 48 kHz symbol are 90 Ts and 640 Ts, respectively, Ts=1000/(15*2048)=0.032552 us; short CP length and useful OFDM symbol duration in 15 kHz symbol are 144 Ts and 2048 Ts, respectively, which is given in FIG. 6, where 32 kHz short symbol structure that has a scalable factor of 2 over 16 kHz SCS is also provided for the comparison, and one short symbol for 15 kHz may be time aligned with (or equal to in time) two short symbols of 32 kHz and three short symbols of 48 kHz. It is noted that the number of samples of 640 in 48 kHz symbol can be factored into prime numbers of 2 and 5 as 640=5*27, which can be applied in efficient DFT processing. Note also that the sampling rate or sampling period is the same for processing 48 kHz and 15 kHz OFDM signals, i.e., the sampling rate is 15000*2048=48000*640, and the sampling period (or sampling time interval)=1/(15000*2048)=1/(48000*640) seconds=32.552 ns (which is Ts).

The length of useful symbol part of the 48 kHz symbol is 1/48000, and because the sampling period is the same which is, 1/(15000*2048), the number of samples for the useful symbol part of the 48 kHz symbol is 1/48000÷(1/(15000*2048)), which is 640, which is its DFT size. And this number is applicable to DFT. Furthermore, in this case, as shown in FIG. 6, the length of a 15 kHz short symbol can be the same as that of three 48 kHz short symbols. The number of samples of short CP of 48 kHz is 90. Thus, the short CP overhead is 90/(90+640)=12.57%.

The length of the 32 kHz short symbol is also shown in FIG. 6. Since the number of samples for the short CP of a 16 kHz short symbol is 272, and the number of samples for the useful symbol part is 1920, the number of samples for the short CP of a 32 kHz short symbol is 136, the number of samples for the useful symbol part is 960. At this point, the length of a 15 kHz short symbol is the same as that of two 32 kHz short symbols, and the overhead of a 32 kHz short CP is still 12.41%.

FIG. 7 shows an alignment within 0.5 ms for 15 kHz and 48 kHz numerology symbols, where for 15 kHz SCS, 0.5 ms includes 1 long symbol (T_{cp_long:} 5.21 us) and 6 short symbols (each T_{cp_short}=4.69 us); for 48 KHz SCS, 0.5 ms includes 1 long symbol (T_{cp_long}: 3.52 us) and 20 short symbols (each T_{cp_short}=2.99 us).

Specifically, in FIG. 7, the number of samples of 48 kHz long symbol is (90+16), or 106. Since the length of a 15 kHz short symbol can be the same as that of three 48 kHz short symbols, half subframe includes one 48 kHz long symbol and 20 number of 48 kHz short symbols.

In addition, the long CP overhead of 48 kHz long symbol is 106/(106+640)=14.4%.

A 48 kHz numerology family with normal CP is shown in FIG. 8, where for example, long CPs and long symbols (each comprising a long CP and a useful OFDM symbol part) are provided, with long CP lengths and overheads estimated.

In the case of 48 kHz, the useful symbol part is 1/48000 in length, or 20.83 us. The number of samples of short CP is 90 and the sampling period is 1/(15000*2048), so the length of short CP is the product of the number of samples and the sampling period, which is 2.99 us. The number of samples of long CP is 106 and the sampling period is 1/(15000*2048), so the length of long CP is 3.52 us.

In addition, the length of the short symbol is the sum of the length of the short CP and the useful symbol part, so it is (20.83+2.99), or about 23.83 us. The length of the long symbol is the sum of the length of the long CP and the useful symbol part, so it is (20.83+3.52), or 24.35 us. The overheads of a 48 kHz long CP and a 48 kHz short CP have been described previously and will not be repeated again herein.

The rest of the information in FIG. 8 is calculated in the same way and will not be repeated again.

In a word, the short CP overhead of the 48 kHz numerology family is about 12.57%, which is higher than that of 15 kHz numerology family, which provides a trade-off that the 48 kHz numerology family has a stronger capacity in dealing with Doppler impact and ISI than 15 kHz numerology family. For example, the short CP length of 60 kHz short symbol is 1.17 us, while the short CP length of 96 kHz short symbol is 1.50 us. It means that short CP of 96 kHz symbol has a stronger capacity in dealing with Doppler impact and ISI with larger SCS at the same time. Thus, the 48 kHz numerology family is applicable to situations that require both large SCS and large CP.

12 (or 48) kHz numerology family with extended CP (ECP) is described in the following.

In this embodiment, 12 kHz numerology family with extend CP are proposed with relatively smaller ECP lengths (or ECP overheads) than 15 kHz numerology family. The OFDM or single-carrier FDMA symbols with ECP allow the system to have only one CP type in a group of symbols (e.g., in 0.5 ms or a half subframe) and all ECP lengths in this family are scalable inversely with subcarrier spacing values.

12 kHz numerology family with ECP and symbol alignment within 0.5 ms is described in the following.

It is noted that 0.5 ms can include a plurality of OFDM symbols, each with an ECP, and each ECP length is the same, which is different from the NCP including one long CP and multiple short CPs of 0.5 ms.

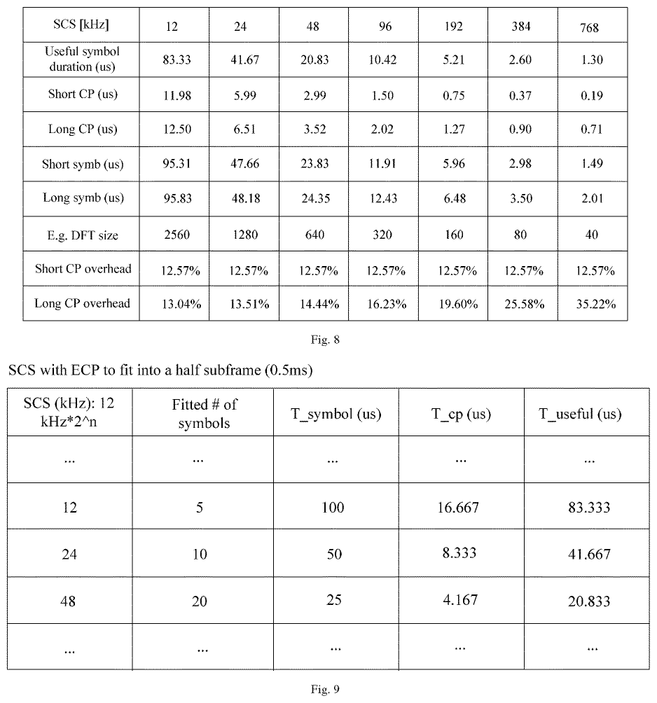

12 kHz numerology family with ECP is shown in FIG. 9. In FIG. 9, 12 kHz numerology family with ECP: 12 kHz*2\hat{ }n, where n is an integer (including negative numbers), n= . . . , 0, 1, 2, . . . , can fit a number of symbols into 0.5 ms or a half subframe duration, and the number of symbols may depend on subcarrier spacing option in the numerology family, as shown in FIG. 9. For example, for 24 kHz symbols, 10 symbols may fit into the 0.5 ms, with symbol duration of 50 us that comprises 8.333 us of ECP length and 41.667 us of useful OFDM symbol part.

Specifically, for 24 kHz SCS, the useful symbol duration is 41.667 us. Because 24 kHz SCS will fit into 0.5 ms, the symbol duration including ECP and useful symbol duration can be set as 50 us. In this condition, the ECP duration for 24 kHz SCS is 8.333 us, and a subframe (0.5 ms) can include 10 of 24 kHz symbols. What's more, the ECP overhead of 24 kHz SCS is about 16.67%, which is smaller than the 20% of ECP of 15 kHz SCS.

Each SCS in the 12 kHz numerology family has the same ECP overhead. So, compared with transmission efficiency of signal when 15 kHz numerology family is used, transmission spectrum efficiency when 12 kHz numerology family is used is higher.

The number of symbols of other SCS in the 12 kHz numerology family that can fit into a subframe is determined by the same way, which will not be described one by one herein.

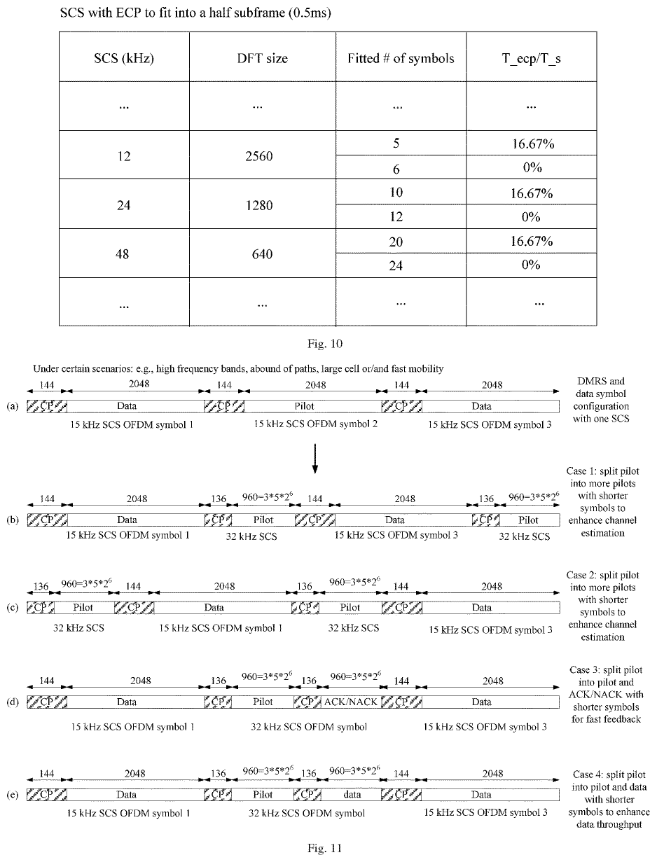

Furthermore, more options on 12 kHz numerology family with ECP: 12 kHz*2\hat{ }n, where n is an integer (including negative numbers), n= . . . , 0, 1, 2, . . . , is shown in FIG. 10. A number of symbols may be fit into 0.5 ms, and ECP overhead (of 16.67%) is also provided. This family can provide a unique feature that 0.5 ms may be able to fit all useful (OFDM) symbol parts with a zero CP overhead. For example, instead of fitting 10 number of 24 kHz symbols into the 0.5 ms with (ECP) overhead of 16.67%, the 0.5 ms can be fit 12 (OFDM) symbol parts or 12 (OFDM) symbols with zero CP. This may maximize the spectrum usage in scenarios where, e.g., OFDM symbols without CP are needed or single-carrier symbol without CP.

That is to say, in this situation, the symbol duration only includes the useful symbol duration, so the ECP duration is 0. Therefore, the ECP overhead is 0. In this case, the number of fitted symbols can be greater than that when ECP duration is not 0.

The number of symbols of other SCSs in the 12 kHz numerology family that can fit into a subframe when ECP duration is 0 is determined by the same way, which will not be described one by one herein.

In this way, because the ECP overhead is zero, the entire time length for an SCS in the 12 kHz numerology family can be used to carry data, thus further improving the transmission spectrum efficiency.

Use cases with 16 kHz and 48 kHz numerology families with normal CP (NCP) are described in the following.

In this embodiment, 16 kHz and 48 kHz numerology families with normal CP with relatively large CP lengths can be used independently or used in a combination with 15 kHz numerology family in some scenarios or use cases, which may require reasonably large CP length to resolve Doppler impact or/and inter-symbol interference (ISI), for example:

Higher frequency bands are used (that may require larger SCS) with wireless environments being full of multi-paths or/and high mobility scenarios.

Application or traffic with low-latency (and high reliability) end-end requirement where a large SCS is required to reduce air-link transmission and feedback time, in wireless environments being full of multi-paths or/and high mobility scenario.

Fast moving network device or/and node communicating among them in environments full of multi-paths.

Carrier aggregation communication with high and low frequency bands in a fast moving scenario or/and in environments full of multi-paths.

Above applicable scenarios have been described in former content, so they will not be described again herein.

For an independent use of the 16 kHz or/and 48 kHz numerology families with normal CP, any of the new numerology family or any SCS in a numerology family may be included in a configuration of a bandwidth part, and thus the usage is similar to one in NR network.

For use with a combination with 15 kHz numerology family, for example, one 15 kHz short symbol may be replaced by one 16 kHz short symbol, or two 32 kHz short symbols or three 48 kHz short symbols, for example, for fast feedback or satisfying relatively large CP requirements. Such a combination usage can be configured semi-statically, e.g., via radio resource control (RRC) or medium access control-control element (MAC-CE) or dynamically, e.g., via downlink control information (DCI).

In some embodiments, in FIG. 11, DL or UL transmission may be configured DMRS symbol(s) (or pilot symbol) and data symbol(s) with one SCS such as 15 kHz (for an easy understanding in difference).

For example, in (a) of FIG. 11, there are three 15 kHz symbols. For each 15 kHz symbol, the short CP duration is 144 Ts, and the useful symbol duration is 2048 Ts. And for the 15 kHz symbol 1 and the 15 kHz symbol 3, the useful symbol part is used to carry data, while for the 15 kHz symbol 2, the useful symbol part is used to carry pilot information. In this case, the 15 kHz symbol 2 can also be called a pilot symbol.

What's more, the DMRS and data symbols may also be configured with a combination of SCSs from different numerology families such as 15 kHz with 16 kHz. For example, we can may configure to replace or split any 15 kHz DMRS (or pilot symbol) or any data symbol into smaller 32 kHz symbols to implement one or more of the following cases.

Case 1: split a pilot symbol into shorter pilot symbols (pilot at rear end) to enhance channel estimation.

Because one 15 kHz short symbol may be replaced by two 32 kHz short symbols, as in (b) of FIG. 11, the pilot symbol can be split into two shorter pilot symbols, with one shorter pilot symbol at rear end. The two shorter pilot symbols are 32 kHz SCS symbols. By doing this, in the same time duration as compared with all 15 kHz symbols, the number of pilot symbols has been increased or the pilot symbols are separated in time to capture channel varying over time, so the channel estimation accuracy can be improved.

Case 2: split a pilot symbol into shorter pilot symbols (pilot at front end) to enhance channel estimation.

Similar with the configuration in case 1, the pilot symbol in (a) can be split into two shorter pilot symbols, with one shorter pilot symbol at front end, as shown in (c) of FIG. 11. By doing this, in the same time duration as compared with all 15 kHz symbols, the number of pilot symbols has been increased or the pilot symbols are separated in time to capture channel varying over time, so the channel estimation accuracy can also be improved.

Case 3: split a pilot symbol into shorter pilot symbol and a short symbol for acknowledgement (ACK)/negative acknowledgement (NACK) to achieve fast feedback.

In addition to the configuration in case 1 and case 2, the pilot symbol in (a) can also be split into one shorter pilot symbol and one symbol for ACK/NACK (the ACK/NACK symbol), as shown in (d) of FIG. 11. Please note that the ACK/NACK symbol can be used to inform the transmitter receiving of data or non-receiving of data. Compared with the configuration without the ACK/NACK symbol (e.g. configuration in (a)), the feedback speed in this case is faster and quicker.

Case 4: split a pilot symbol into shorter pilot symbol and a short symbol for data to enhance data throughput.

What's more, the pilot symbol in (a) can also be split into one shorter pilot symbol and one symbol for carrying data (the data symbol), as shown in (e) of FIG. 11. By doing so, in the same time duration as compared with all 15 kHz symbols, more symbols can be used for the data transmission, thus improving data transmission efficiency and throughput.

For above cases, for example, replacing or splitting a 15 kHz data symbol into two 32 kHz symbols for these purposes are allowed. But embodiments of this application will not be limited in this configuration. That is to say, the 15 kHz data symbol can also be replaced by symbols from other numerology families. The number of 15 kHz data symbols that are replaced is also not restricted herein. Also, any SCS option in the 15 kHz numerology family can work with any SCS option in the proposed numerology families with a combination usage to enhance the transmission quality, spectrum efficiency or/and data throughput for applications or services.

For actual configuration on a combination usage of different SCSs from different numerology families, there is no need to use 15 kHz as reference configuration as shown in FIG. 11. For example, the SCS configuration on each of symbols in a slot or 0.5 ms duration can be directly indicated or provided with any SCS option and NCP option, where the configuration can be provided semi-statically, e.g., via RRC or MAC-CE or dynamically, e.g., via DCI.

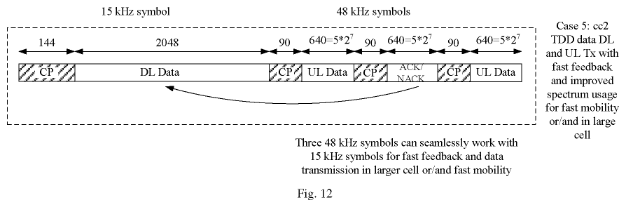

In other embodiments, in FIG. 12, DL and UL transmissions may be configured symbols with different SCSs (15 kHz and 48 kHz) from different numerology families to achieve fast feedback for use cases such as URLLC (Ultra-Reliable Low-Latency Communications) that requires low-latency and high reliability.

Illustratively, in FIG. 12, for DL transmission, the 15 kHz symbol can be used, while for UL transmission, the 48 kHz symbols can be used, and the 48 kHz symbol in the middle is an ACK/NACK symbol. In this way, when a user equipment (UE) receives a DL data, after UE decodes the DL data, it can send the ACK message in the UL transmission to inform base station that it has received the DL data correctly or not. Therefore, the feedback speed of using 48 kHz symbol(s) can be faster than that of using 15 kHz symbol in the UL transmission; because when 15 kHz symbol is used in the UL transmission, the feedback will not be sent during the time duration when 48 kHz symbols are transmitted, in that there is no symbol for ACK during the time duration.

Use cases with 12 kHz numerology family with ECP are described in the following.

In this embodiment, 12 kHz numerology family with ECP with relatively large CP lengths can be used independently or used in a combination with 15 kHz numerology family in some scenarios or use cases, which may require reasonably large CP length to resolve Doppler impact or/and inter-symbol interference (ISI), for example:

Higher frequency bands are used (that may require larger SCS) with wireless environments being full of multi-paths or/and high mobility scenarios.

Application or traffic with low-latency (and high reliability) end-end requirement where a large SCS is required to reduce air-link transmission and feedback time, in wireless environments being full of multi-paths or/and high mobility scenario.

Fast moving network device or/and node communicating among them in environments full of multi-paths.

Carrier aggregation communication with high and low frequency bands in a fast moving scenario or/and in environments full of multi-paths.

For a use of the 12 kHz numerology family with ECP, any SCS in the numerology family may be included in a configuration of a bandwidth part.

Multiple symbols in a time duration of 0.5 ms or a half subframe with one or more SCSs in the 12 kHz numerology family with ECP can be configured (as a basic configuration time unit); for example, one 0.5 ms duration may be configured with SCS symbols in the 12 kHz numerology family such as 10 24 kHz symbols, and another 0.5 ms duration can be configured with same SCS symbols (e.g., 24 kHz symbols), any other SCS symbols in the 12 kHz numerology family (e.g., 12 kHz or 48 kHz symbols), or any SCS symbols in other numerology family such as 15 kHz.

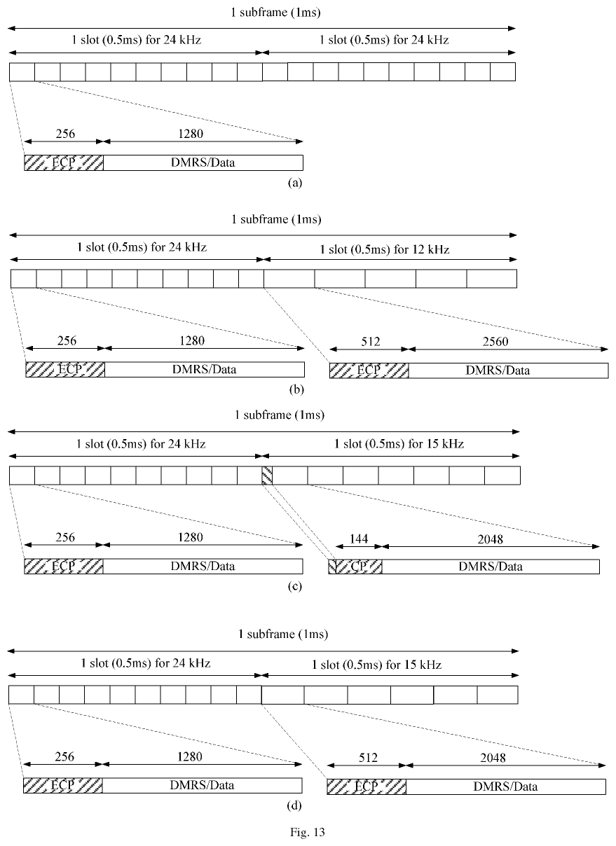

For example, in (a) of FIG. 13, the first 0.5 ms includes 10 number of 24 kHz symbols, and for each 24 kHz symbol, ECP length is 8.333 us (256 Ts) and useful symbol length is 41.667 us (1280 Ts). The second 0.5 ms also includes 10 number of 24 kHz symbols.

In (b) of FIG. 13, the first 0.5 ms includes 10 number of 24 kHz symbols, and the second 0.5 ms includes 5 number of 12 kHz symbols. For each 12 kHz symbol, ECP length is 16.667 us (512 Ts) and useful symbol length is 83.333 us (2560 Ts).

In (c) of FIG. 13, the first 0.5 ms includes 10 number of 24 kHz symbols, and the second 0.5 ms includes 7 number of 15 kHz symbols. For each 15 kHz symbol, long CP length is 5.21 us (160 Ts), short CP length is 4.69 us (144 Ts) and useful symbol length is 66.7 us (2048 Ts).

In (d) of FIG. 13, the first 0.5 ms includes 10 number of 24 kHz symbols, and the second 0.5 ms includes 6 number of 15 kHz symbols with ECP. For each 15 kHz symbol, ECP length is 16.667 us (512 Ts), and useful symbol length is 66.7 us (2048 Ts), where the FFT size for ECP is calculated by {16+7*(144+2048)−6*2048}/6=512. Thus, the overhead of the ECP is 512/(512+2048)=20%.

As a result, a time duration may be configured with SCS symbols in one numerology family such as 15 kHz or 12 kHz, and another time duration may be configured with SCS symbols in another numerology family such as 12 kHz or 15 kHz. In some embodiments, one frame (e.g., 10 ms) or one subframe (e.g., 1 ms) may be configured with SCS symbols in the same numerology family (e.g., 12 kHz or 15 kHz); for example, one subframe comprising two 0.5 ms durations may have one 0.5 ms duration configured with 7 number of 15 kHz symbols and the other 0.5 ms duration configured with 14 number of 30 kHz symbols. In other embodiments, one frame (e.g., 10 ms) or one subframe (e.g., 1 ms) may be configured over each time unit of 0.5 ms with SCS symbols from different numerology families; for example, one subframe comprising two 0.5 ms durations may have one 0.5 ms duration configured with 7 number of 15 kHz symbols and the other 0.5 ms duration configured with 10 24 kHz symbols (or 20 48 kHz symbols).

In above operations, SCSs from one or more numerology families such as 15 kHz and 12 kHz may be configured semi-statically, e.g., via RRC or MAC-CE or dynamically, e.g., via DCI.

Above embodiments don't represent all embodiments of this application. Each symbol of time unit of 0.5 ms may be different, and each time unit of 0.5 ms of one subframe/one frame may also be different, which will not be restricted in this application.

The disclosed 12 kHz and 16 kHz numerology families for NCP employ relatively higher CP length with relatively large SCS, so the families are applicable to the scenarios such as using high frequency bands, with abound of multi-paths, large cell or/and fast mobility situations. What's more, the disclosed 12 kHz numerology family also provides SCS options with ECP to enhance directly the transmission spectrum efficiency as the ECP overhead of 12 kHz numerology family is lower than that of 15 kHz numerology family.

New numerology families disclosed in this application can be used in communication field, specifically in 6G, 5G, 4G communication system.

Referring to FIG. 14, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

FIG. 15 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a, 110b, and 110c or both, and (ii) other networks (such as the PSTN 140, the internet 150, and the other networks 160). In addition, some or all of the EDs 110a, 110b, and 110c may include functionality for communicating with different wireless networks over different wireless links using different wireless technologies and/or protocols. Instead of wireless communication (or in addition thereto), the EDs 110a, 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a, 110b, and 110c may be multimode devices capable of operation according to multiple radio access technologies, and incorporate multiple transceivers necessary to support such.

FIG. 16 illustrates another example of an ED 110 and a base station 170a, 170b and/or 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 16, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 14). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forging devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 17. FIG. 17 illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The followings are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept”. For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:
(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.
(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.
(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.
(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.
(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. mulit-path delay, Doppler); and/or latency requirement; and/or available time duration. As another example, a symbol block length may be adjusted to fit an available time duration in the frame.
(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

In current networks, frame timing and synchronization is established based on synchronization signals, such as a primary synchronization signal (PSS) and a secondary synchronization signal (SSS). Notably, known frame timing and synchronization strategies involve adding a timestamp, e.g., (xx0:yy0:zz), to a frame boundary, where xx0, yy0, zz in the timestamp may represent a time format such as hour, minute, and second, respectively.

It is anticipated that diverse applications and use cases in future networks may involve usage of different periods of frames, slots and symbols to satisfy the different requirements, functionalities and Quality of Service (QoS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

The present disclosure relates, generally, to mobile, wireless communication and, in particular embodiments, to a frame timing alignment/realignment, where the frame timing alignment/realignment may comprise a timing alignment/realignment in terms of a boundary of a symbol, a slot or a sub-frame within a frame; or a frame (thus the frame timing alignment/realignment here is more general, not limiting to the cases where a timing alignment/realignment is from a frame boundary only). Also, in this application, relative timing to a frame or frame boundary should be interpreted in a more general sense, i.e., the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In overview, aspects of the present application relate to a network device, such as a base station 170, referenced hereinafter as a TRP 170, transmitting signaling that carries a timing realignment indication message. The timing realignment indication message includes information allowing a receiving UE 110 to determine a timing reference point. On the basis of the timing reference point, transmission of frames, by the UE 110, may be aligned. In some aspects of the present application, the frames that become aligned are in different sub-bands of one carrier frequency band. In other aspects of the present application, the frames that become aligned are found in neighboring carrier frequency bands.

On the TRP 170 side, aspects of the present application relate to use of one or more types of signaling to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 110 of a configuration of a timing reference point. References, hereinafter, to the term “UE 110” may be understood to represent reference to a broad class of generic wireless communication devices within a cell (i.e., a network receiving node, such as a wireless device, a sensor, a gateway, a router, etc.), that is, being served by the TRP 170. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, e.g., the start of the current frame. Alternatively, the timing reference point may be expressed in terms of an absolute timing based on certain standards timing reference such as a GNSS (e.g., GPS), Coordinated Universal Time (“UTC”), etc. In the absolute timing version of the timing reference point, a timing reference point may be explicitly stated.

The timing reference point may be shown to allow for timing adjustments to be implemented at the UEs 110. The timing adjustments may be implemented for improvement of accuracy for a clock at the UE 110. Alternatively, or additionally, the timing reference point may be shown to allow for adjustments to be implemented in future transmissions made from the UEs 110. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs and one or more BSs (in a cell or a group of cells), which applies across the application below.

At UE 110 side, the UE 110 may monitor for the timing realignment indication message. Responsive to receiving the timing realignment indication message, the UE 110 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 110 may cause the TRP 170 to transmit the timing realignment indication message by transmitting, to the TRP 170, a request for a timing realignment, that is, a timing realignment request message. Responsive to receiving the timing realignment request message, the TRP 170 may transmit, to the UE 110, a timing realignment indication message including information on a timing reference point, thereby allowing the UE 110 to implement a timing realignment (or/and a timing adjustment including clock timing error correction), wherein the timing realignment is in terms of (e.g., a starting boundary of) a symbol, a slot or a sub-frame within a frame; or a frame for UEs and base station(s) in a cell (or a group of cells).

According to aspects of the present application, a TRP 170 associated with a given cell may transmit a timing realignment indication message. The timing realignment indication message may include enough information to allow a receiver of the message to obtain a timing reference point. The timing reference point may be used, by one or more UEs 110 in the given cell, when performing a timing realignment (or/and a timing adjustment including clock timing error correction).

According to aspects of the present application, the timing reference point may be expressed, within the timing realignment indication message, relative to a frame boundary (where, as previously described and to be applicable below across the application, a frame boundary can be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, i.e., Δt, subsequent to a frame boundary for a given frame. Since the frame boundary is important to allowing the UE 110 to determine the timing reference point, it is important that the UE 110 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a Master Information Block (MIB) and the remaining four bits of the 10 bits for the SFN may be carried in a Physical Broadcast Channel (PBCH) payload.

Optionally, the timing realignment indication message may include other parameters. The other parameters may, for example, include a minimum time offset. The minimum time offset may establish a duration of time preceding the timing reference point. The UE 110 may rely upon the minimum time offset as an indication that DL signaling, including the timing realignment indication message, will allow the UE 110 enough time to detect the timing realignment indication message to obtain information on the timing reference point.

### 6G Integrated Sensing and Communication

### Generic Background

User Equipment (UE) position information is often used in cellular communication networks to improve various performance metrics for the network. Such performance metrics may, for example, include capacity, agility, and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including its location in a global coordinate system, its velocity and direction of movement in the global coordinate system, orientation information, and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency, or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

### Sensing Node, Sensing Management Function

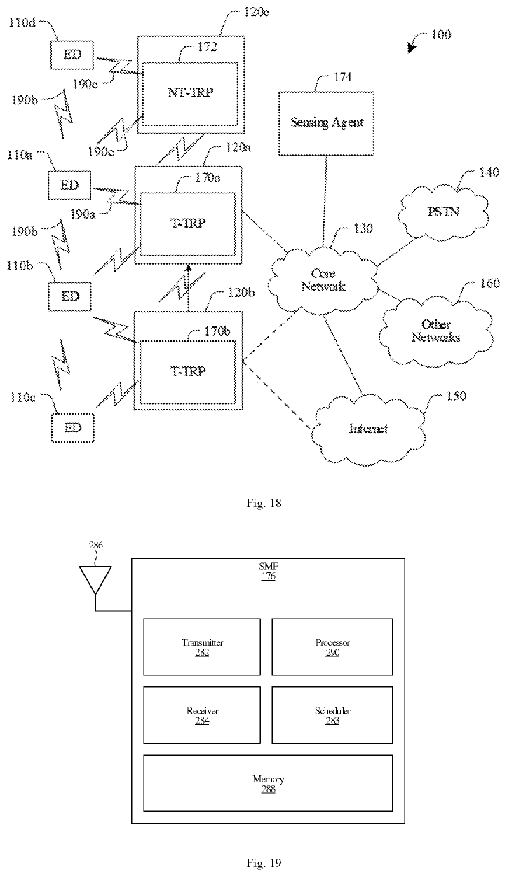

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. Referring to FIG. 18, the sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 18, any number of sensing agents may be implemented in the communication system 100. In some embodiments, one or more sensing agents may be implemented at one or more of the RANs 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

As shown in FIG. 19, the SMF 176, when implemented as a physically independent entity, includes at least one processor 290, at least one transmitter 282, at least one receiver 284, one or more antennas 286, and at least one memory 288. A transceiver, not shown, may be used instead of the transmitter 282 and receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing, or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array, or application specific integrated circuit.

A reference signal-based pose determination technique belongs to an “active” pose estimation paradigm. In an active pose estimation paradigm, the enquirer of pose information (i.e., the UE) takes part in process of determining the pose of the enquirer. The enquirer may transmit or receive (or both) a signal specific to pose determination process. Positioning techniques based on a global navigation satellite system (GNSS) such as Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space based sensing to reduce sensing complexity and improve sensing accuracy.

### Sensing Channel

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal, and a second set of channels may be used to transmit a communications signal. In some embodiments, each channel in the first set of channels and each channel in the second set of channels is a logical channel, a transport channel, or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) is used to carry control information for both sensing and communication. Alternatively, separate physical layer control channels may be used to carry separate control information for communication and sensing. For example, PUCCH-S and PUCCH-C could be used for uplink control for sensing and communication respectively, and PDCCH-S and PDCCH-C for downlink control for sensing and communication respectively.

Different combinations of shared and dedicated channels for sensing and communication, at each of the physical, transport, and logical layers, are possible.

### Radar

The term RADAR originates from the phrase Radio Detection and Ranging; however, expressions with different forms of capitalization (i.e., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static, or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

### Half-Duplex and Full-Duplex

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g. in the millimeter wave bands), and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node have full-duplex capability. A half-duplex node may perform monostatic sensing with certain limitations, such as in a pulsed radar with a specific duty cycle and ranging capability.

### Sensing Signal Waveform and Frame Structure

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

### Precoding

Precoding as used herein may refer to any coding operation(s) or modulation(s) that transform a [ . . . ] input signal into a [ . . . ] output signal. Precoding may be performed in different domains, and typically transform the input signal in a first domain to an output signal in a second domain. Precoding may include linear operations.

### 6G Integrated TN &NTN

A terrestrial communication system may also be referred to as a land-based or ground-based communication system, although a terrestrial communication system can also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communications using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communications using the satellite constellations like conventional Geo-Stationary Orbit (GEO) satellites which utilizing broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

### 6G MIMO

Multiple input multiple-output (MIMO) technology allows an antenna array of multiple antennas to perform signal transmissions and receptions to meet high transmission rate requirement. The above ED110 and T-TRP 170, and/or NT-TRP use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves for dozens of the ED 110 (such as 40) in the meanwhile. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and an ED 110 is obviously reduced, and the power efficiency is greatly increased. When the antenna number of the T-TRP 170, and/or NT-TRP 172 is sufficiently large, random channels between each ED 110 and the T-TRP 170, and/or NT-TRP 172 can approach to be orthogonal, and the interference between the cell and the users and the effect of noises can be eliminated. The plurality of advantages described above enable the large-scale MIMO to have a magnificent application prospect.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:

Panel: unit of antenna group, or antenna array, or antenna sub-array which can control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier.

### 6G AI/ML

Artificial Intelligence technologies can be applied in communication, including artificial intelligence or machine learning (AI/ML) based communication in the physical layer and/or AI/ML based communication in the higher layer, e.g., medium access control (MAC) layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, e.g. to optimize the functionality in the MAC layer, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

The following are some terminologies which are used in AI/ML field:

### Data Collection

Data is the very important component for AI/ML techniques. Data collection is a process of collecting data by the network nodes, management entity, or UE for the purpose of AI/ML model training, data analytics and inference.

### AI/ML Model Training

AI/ML model training is a process to train an AI/ML Model by learning the input/output relationship in a data driven manner and obtain the trained AI/ML Model for inference.

### AI/ML Model Inference

A process of using a trained AI/ML model to produce a set of outputs based on a set of inputs.

### AI/ML Model Validation

As a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.

### AI/ML Model Testing

Similar with validation, testing is also a sub-process of training, and it is used to evaluate the performance of a final AI/ML model using a dataset different from the one used for model training and validation. Differently from AI/ML model validation, testing do not assume subsequent tuning of the model.

### Online Training:

Online training means an AI/ML training process where the model being used for inference is typically continuously trained in (near) real-time with the arrival of new training samples.

### Offline Training:

An AI/ML training process where the model is trained based on collected dataset, and where the trained model is later used or delivered for inference.

### AI/ML Model Delivery/Transfer

A generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in NR air-interface.

Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring can be based on inference accuracy, including metrics related to intermediate key performance indicator (KPI) s, and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to the environment changes, thus the model based on input or output data distribution should also be considered.

### Supervised Learning:

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

Supervised learning can be further divided into two types: Classification and Regression. Classification is used when the output of the AI/ML model is categorical i.e. with two or more classes. Regression is used when the output of the AI/ML model is a real or continuous value.

### Unsupervised Learning:

In contrast to supervised learning where the AI/ML models learn to map the input to the target output, the unsupervised methods learn concise representations of the input data without the labelled data, which can be used for data exploration or to analyze or generate new data. One typical unsupervised learning is clustering which explores the hidden structure of input data and provide the classification results for the data.

### Reinforce Learning:

Reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent can take the next action based on the received reward and new state in the environment. During the training phase, the agent interacts with the environment to collect experience. The environments often mimicked by the simulator since it is expensive to directly interact with the real system. In the inference phase, the agent can use the optimal decision-making rule learned from the training phase to achieve the maximal accumulated reward.

### Federated Learning:

Federated learning (FL) is a machine learning technique that is used to train an AI/ML model by a central node (e.g., server) and a plurality of decentralized edge nodes (e.g., UEs, next Generation NodeBs, “gNBs”).

According to the wireless FL technique, a server may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure are performed multiple iterations until the global AI/ML model is considered to be finalized, e.g., the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

An AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, e.g. to optimize one or more components of the air interface, will be referred to herein as an “AI enabled air interface”. In some embodiments, there may be two types of AI operation in an AI enabled air interface: both the network and the UE implement learning; or learning is only applied by the network.

A person of ordinary skill in the art may be aware that, in combination with the examples described in embodiments disclosed in this specification, units and methods may be implemented by electronic hardware or a combination of computer software and electronic hardware. Whether the functions are performed by hardware or software may depend on particular applications and design constraints of the technical solutions. A person skilled in the art may use different methods to implement the described functions for each particular application, but it should not be considered that the implementation goes beyond the protection scope of this application.

The units described as separate parts may or may not be physically separate, and parts displayed as units may or may not be physical units, may be located in one position, or may be distributed on a plurality of network units. Some or all of the units may be selected based on an actual requirement to implement the solutions provided in this application.

All or some of the foregoing embodiments may be implemented by using software, hardware, firmware, or any combination thereof. When the software is used to implement embodiments, all or a part of embodiments may be implemented in a form of a computer program product. The computer program product includes one or more computer instructions. When the computer program instructions are loaded and executed on the computer, the procedures or functions according to embodiments of this application are all or partially generated. The computer may be a general-purpose computer, a special-purpose computer, a computer network, or another programmable apparatus. For example, the computer may be a personal computer, a server, a network device, or the like. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, an SSD), or the like. For example, the usable medium may include but is not limited to any medium that can store program code, such as a USB flash drive, a removable hard disk, a ROM, a RAM, a magnetic disk, or an optical disc.

The foregoing description is merely a specific implementation of this application, but is not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims and the specification.

What is claimed is:

1. An apparatus, comprising:
one or more processors coupled with one or more memories storing instructions that, when executed by the one or more processors, cause the apparatus to:
receive, from a base station, a signaling configuring a numerology in a time duration, wherein the configuring a numerology in a time duration comprises configuring a subcarrier spacing (SCS) for one or more symbols in the time duration, each symbol of the one or more symbols comprising a cyclic prefix (CP) part and a useful orthogonal frequency division multiplexing (OFDM) signal part, a time length of the useful OFDM signal part is an inverse of the SCS, a number of sampling samples of the useful OFDM signal part is an integer multiple of at least one of prime numbers 3 or 5, a time length of the CP part is in units of k sampling samples, and k is a non-negative integer; and
communicate with the base station using the numerology.

2. The apparatus of claim 1, wherein the time duration is a subframe of 1 millisecond (ms) or a half subframe of 0.5 ms.

3. The apparatus of claim 2, wherein the SCS belongs to a family of scalable SCSs of 16×2ⁿ kHz or a family of scalable SCSs of 12×2ⁿ kHz, and n is an integer.

4. The apparatus of claim 3, wherein:
the time length of the CP part comprises two types of lengths for a short CP part and a long CP part, respectively, which are referred to as normal CPs; and
a first symbol comprising the long CP part and the useful OFDM signal part is referred to as a long symbol, and a second symbol comprising the short CP part and the useful OFDM signal part is referred to as a short symbol.

5. The apparatus of claim 4, wherein a time length difference between the long symbol and the short symbol has a fixed time length of M sampling samples, and M is an integer multiple of 16.

6. The apparatus of claim 5, wherein when the SCS belongs to the family of scalable SCSs of 12×2ⁿ kHz, for a 48 kHz symbol, the number of sampling samples of the useful OFDM signal part or DFT size is 640, a number of sampling samples of the short CP part is 90, and a number of sampling samples of the long CP part is 106.

7. The apparatus of claim 3, wherein one or more symbols from the family of scalable SCSs of 16×2ⁿ kHz or the family of scalable SCSs of 12×2ⁿ kHz are used to replace one or more symbols from a family of scalable SCSs of 15×2ⁿ kHz, and wherein n is an integer.

8. A method, comprising:
receiving, from a base station, a signaling configuring a numerology in a time duration, wherein the configuring a numerology in a time duration comprises configuring a subcarrier spacing (SCS) for one or more symbols in the time duration, each symbol of the one or more symbols comprising a cyclic prefix (CP) part and a useful orthogonal frequency division multiplexing (OFDM) signal part, a time length of the useful OFDM signal part is an inverse of the SCS, a number of sampling samples of the useful OFDM signal part is an integer multiple of at least one of prime numbers 3 or 5, a time length of the CP part is in units of k sampling samples, and k is a non-negative integer; and
communicating with the base station using the numerology.

9. The method of claim 8, wherein the time duration is a subframe of 1 millisecond (ms) or a half subframe of 0.5 ms.

10. The method of claim 9, wherein the SCS belongs to a family of scalable SCSs of 16×2ⁿ kHz or a family of scalable SCSs of 12×2ⁿ kHz, and n is an integer.

11. The method of claim 10, wherein:
the time length of the CP part comprises two types of lengths for a short CP part and a long CP part, respectively, which are referred to as normal CPs; and
a first symbol comprising the long CP part and the useful OFDM signal part is referred to as a long symbol, and a second symbol comprising the short CP part and the useful OFDM signal part is referred to as a short symbol.

12. The method of claim 11, wherein a time length difference between the long symbol and the short symbol has a fixed time length of M sampling samples, and M is an integer multiple of 16.

13. The method of claim 12, wherein when the SCS belongs to the family of scalable SCSs of 12×2ⁿ kHz, for a 48 kHz symbol, the number of sampling samples of the useful OFDM signal part or DFT size is 640, a number of sampling samples of the short CP part is 90, and a number of sampling samples of the long CP part is 106.

14. An apparatus, comprising:
one or more processors coupled with one or more memories storing instructions that, when executed by the one or more processors, cause the apparatus to:
transmit, to a user equipment, a signaling configuring a numerology in a time duration, wherein the configuring a numerology in a time duration comprises configuring a subcarrier spacing (SCS) for one or more symbols in the time duration, each symbol of the one or more symbols comprising a cyclic prefix (CP) part and a useful orthogonal frequency division multiplexing (OFDM) signal part, a time length of the useful OFDM signal part is an inverse of the SCS, a number of sampling samples of the useful OFDM signal part is an integer multiple of at least one of prime numbers 3 or 5, a time length of the CP part is in units of k sampling samples, and k is a non-negative integer; and
communicate with the user equipment using the numerology.

15. The apparatus of claim 14, wherein the time duration is a subframe of 1 millisecond (ms) or a half subframe of 0.5 ms.

16. The apparatus of claim 15, wherein the SCS belongs to a family of scalable SCSs of 16×2ⁿ kHz or a family of scalable SCSs of 12×2ⁿ kHz, and n is an integer.

17. The apparatus of claim 16, wherein:
the time length of the CP part comprises two types of lengths for a short CP part and a long CP part, respectively, which are referred to as normal CPs; and
a first symbol comprising the long CP part and the useful OFDM signal part is referred to as a long symbol, and a second symbol comprising the short CP part and the useful OFDM signal part is referred to as a short symbol.

18. The apparatus of claim 17, wherein a time length difference between the long symbol and the short symbol has a fixed time length of M sampling samples, and M is an integer multiple of 16.

19. The apparatus of claim 18, wherein when the SCS belongs to the family of scalable SCSs of 12×2ⁿ kHz, for a 48 kHz symbol, the number of sampling samples of the useful OFDM signal part or DFT size is 640, a number of sampling samples of the short CP part is 90, and a number of sampling samples of the long CP part is 106.

20. The apparatus of claim 16, wherein one or more symbols from the family of scalable SCSs of 16×2ⁿ kHz or the family of scalable SCSs of 12×2ⁿ kHz are used to replace one or more symbols from a family of scalable SCSs of 15×2ⁿ kHz, and wherein n is an integer.
